(19) United States
(12) Patent Application Publication
(10) Pub. No.: US 2023/0040204 A1
(43) Pub. Date: Feb. 9, 2023

(54) Locking Hoseclamp Device

(71) Applicant: Gary Jungers, Paris, TN (US)

(72) Inventor: Gary Jungers, Paris, TN (US)

(21) Appl. No.: 17/880,726

(22) Filed: Aug. 4, 2022

Related U.S. Application Data
(60) Provisional application No. 63/229,171, filed on Aug. 4, 2021.

(51) Int. Cl. F16L 21/08; F16L 21/06

(52) U.S. Cl. CPC F16L 21/08; F16L 21/065

(57) ABSTRACT

The present invention relates to a novel locking hose clamp device. The device is designed to function as a locking nut and remain tight. The device comprises a lock washer and an insert component. The device can be applied to a clamp and secured with a screw. The insert component is positioned around the screw, such that the screw is threaded into the insert component. The locking washer is secured around the screw, behind the head of the screw. When the user tightens the device, the screw threads catch onto corresponding threads within the insert component. The screw is threaded into the insert component and tightened down, such that the head of the screw contacts an edge of the insert component. The locking washer is then compressed which causes the screw to lock in place.

### CROSS-REFERENCE TO RELATED APPLICATION

The present application claims priority to, and the benefit of, U.S. Provisional Application No. 63/229,171, which was filed on Aug. 4, 2021, and is incorporated herein by reference in its entirety.

### FIELD OF THE INVENTION

The present invention relates generally to the field of locking hose clamp devices. More specifically, the present invention relates to an improved locking hose clamp device that provides users with a small, easy to assemble locking hose clamp for locking hoses in place to prevent leakages and spills. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in locking hose clamp devices. Hose clamps are utilized in virtually all areas of construction and manufacturing. They are used on everything from radiators to hydraulic and air hoses, as well as vacuums. Despite their multi-functionality, hose clamps also present their own problems. Hose clamps often loosen up over time due to vibrational disruptions from the machines they are hooked up to, and from continuous movement of the hoses' internal contents. Thus, maintaining the tightness of threaded fasteners presents difficulties, particularly when the apparatus upon which the fastener is secured or the fastener itself is subjected to frequent shaking or vibration, or periodic impacts. Such occurrences can result in the fastener loosening significantly in a relatively short period of time.

Furthermore, when clamps fail to hold properly, serious maintenance issues can result. When loose clamps give way, it causes leaks and spills. Not only are leaks and spills inconvenient and time consuming to clean up, but they can be a major safety issue, especially in manufacturing plants. Hose clamp mishaps result in increased down time and lost productivity. They also result in costly repairs, including maintenance for the broken machines and the added expenses of replacing the oil, water, or other material lost in a spill. Manufacturing companies and consumers need a device which will circumvent these major issues and provide assurance that their hoses are safely secured in place.

Thus, it is necessary for users to have a locking hose clamp device that enables users to securely lock their hoses in place to prevent leakages and spills. The locking hose clamp device is ideal for use in manufacturing plants and for everyday use by individuals working on vehicles such as cars, motorcycles, boat homes, and even jet skis. Further, there is a need in the art for a locking hose clamp device that is simply slipped over and secured to the seat, by way of a stabilizing means, in an effortless manner, and is removed and discarded after a single use.

Therefore, there exists a long-felt need in the art for a locking hose clamp device that provides users with a small, easy to assemble and use locking hose clamp for everyday use. There is also a long-felt need in the art for a locking hose clamp device that is available in various sizes to accommodate different hoses and clamps for any job. Further, there is a long-felt need in the art for a locking hose clamp device that enables users to securely lock their hoses in place to prevent leakages and spills. Moreover, there is a long-felt need in the art for a device that features a poly/nylon insert which catches on screw grooves to prevent movement. Further, there is a long-felt need in the art for a locking hose clamp device that offers assurance to manufacturers that hoses and clamps will not loosen or give way. Finally, there is a long-felt need in the art for a locking hose clamp device that remains tight even when the apparatus upon which the device is secured or the device itself is subject to frequent shaking or vibration, or periodic impacts.

The subject matter disclosed and claimed herein, in one embodiment thereof, comprises a locking hose clamp device. The device is designed to function as a locking nut and remain tight. The device comprises a lock washer and an insert component made of nylon or poly. The device can be applied to a clamp and secured with a screw. The insert component is positioned around the screw, such that the screw is threaded into the insert component. The locking washer is secured around the screw, behind the head of the screw. When the user tightens the device, the screw threads catch onto corresponding threads within the insert component. The screw is threaded into the insert component and tightened down, such that the head of the screw contacts an edge of the insert component. The locking washer is then compressed which causes the screw to lock in place. Specifically, the locking washer is compressed by the screw head, such that the ends of the locking washer align. This allows the screw to hold tight, reducing friction and preventing vibrations from loosening it. Further, the clamps can vary in size depending on what type of object the device is being used for. The bigger the screw, the bigger the insert component and locking washer will be.

In this manner, the locking hose clamp device of the present invention accomplishes all of the foregoing objectives and provides users with a device that enables users to securely lock their hoses in place to prevent leakages and spills. The device provides users with a small, easy to assemble and use locking hose clamp for everyday use. The device remains tight and can be used in manufacturing plants and/or on vehicles, boats, motorcycles, etc.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a locking hose clamp device. The device is designed to function as a locking nut and remain tight. The device comprises a lock washer and an insert component. The device can be applied to a clamp and secured with a screw. The insert component is positioned around the screw, such that the screw is threaded into the insert component. The locking washer is secured around the screw, behind the head of the screw. When the user tightens the device, the screw threads catch onto corresponding threads within the insert component. The screw is threaded into the insert component and tightened down, such that the head of the screw contacts an edge of the insert component. The locking washer is then compressed which causes the screw to lock in place.

In one embodiment, the insert component comprises a cylindrical housing for accepting a screw or other threaded securing means. The cylindrical housing can be any suitable size and shape as is known in the art, as long as the housing can retain a suitable screw. The cylindrical housing comprises a top side, a bottom side, and a pair of opposing sides. Further, the cylindrical housing comprises a front face, a rear face, and an interior cavity. The front face further includes an opening for accessing the interior cavity. The rear face also includes an opening for accessing the interior cavity. In one embodiment, the rear face is closed and does not include an opening. The interior cavity comprises internal threads which engage with the threads of a screw to secure the screw within the interior cavity. Any suitable number of threads can be utilized within the interior cavity as is known in the art.

In one embodiment, the pair of opposing sides of the cylindrical housing secure around a suitable clamp. Any suitable clamp can be utilized, as is known in the art.

In one embodiment, the screw is a typical screw as is known in the art, with a screw head, a conical body, and a screw tip. The conical body comprises a plurality of threads for engaging with the internal threads of the insert component. Any suitable number of threads can be utilized as is known in the art.

In one embodiment, the locking washer is an essentially annular body having a first face, a second face, an inner edge, and an outer edge. The locking washer further includes first and second ends, respectively, and a central opening, forming a split helical locking washer. The locking washer can be manufactured in different sizes, to be used with threaded fasteners of a wide variety of diameters. Thus, the diameter of the central opening, the width of the locking washer between inner edge and outer edge, and the thickness of the locking washer between the first face and the second face all can be varied as necessary for the specific application and the use to which the locking washer will be placed into.

Generally, the locking washer can be made of a wide variety of materials, commonly metal such as various steels, brass, etc. Further, platings and/or coatings can also be applied to the locking washer as well. In one embodiment, the locking washer is comprised of suitable dimensions and formed from a single piece of high carbon spring steel, hot rolled, or cold drawn, with an opening punched therethrough for the reception of a screw or other securing means as is known in the art. Specifically, the locking washer is made from a single piece folded upon itself creating an upper end and a lower end, wherein the ends are spaced apart in a resting position.

Additionally, in a resting position, the ends of the locking washer do not touch and rest slightly adjacent each other. However, once the screw is threaded into the insert component and tightened down, the head of the screw contacts an edge of the insert component, compressing the locking washer such that its ends now abut and contact each other without overlapping.

Specifically, when the screw is screwed tightly against the locking washer under sufficient pressure, it will cause the locking washer to flatten out, hence its high spring resistance will be exerted to maintain the screw in tight contact with the threads of the insert component, and when the screw is loosened, the locking washer will spring back into resting position.

Additionally, when the screw is tightly adjusted in its locked position in contact with the locking washer, the screw will rest upon the face of the locking washer, which formation securely prevents the screw from turning in either direction, thereby preventing the screw from loosening, while the spring resistance of the locking washer and its compression by the screw exerts sufficient pressure to maintain the screw in a locked position in contact with the threads of the insert component under any and all conditions of service.

In one embodiment, the locking washer includes texturing provided on at least one of the first face and/or the second face. Preferably, texturing is present on both the first face and the second face. Texturing comprises a plurality of individual dimples, or other depressions in the first face and the second face. For example, texturing can comprise randomly positioned dimples or geometrically ordered depressions, such as inverted pyramids pressed into each face. Texturing provides frictional resistance between the surface of the locking washer and the material against which the locking washer rests, to resist vibration or other movement. The textured surface reduces the surface area coming into contact with the meeting material, thereby creating greater surface friction as compared to a standard, smooth, non-textured helical washer. The textured surface is configured in such a way as to not adversely mar or otherwise effect the mating material surface.

In yet another embodiment, the locking hose clamp device comprises a plurality of indicia.

In yet another embodiment, a method of locking hoses in place to prevent leaks and spills is described. The method includes the steps of providing a locking hose clamp device comprising a locking washer and an insert component applied to a clamp. The method also comprises positioning the locking washer on the screw behind the screw head. Further, the method comprises threading the screw into the insert component and tightening it down, such that the head of the screw contacts an edge of the insert component. Finally, compressing the locking washer which causes the screw to lock in place.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the locking hose clamp device of the present invention used to secure a garden hose in accordance with the disclosed architecture;

FIG. 2 illustrates a perspective view of one potential embodiment of the locking hose clamp device of the present invention disclosing the insert component which accommodates a threaded screw in accordance with the disclosed architecture;

FIG. 3 illustrates a perspective view of one potential embodiment of the locking hose clamp device of the present invention disclosing how the screw is inserted into the insert component in accordance with the disclosed architecture;

FIG. 4 illustrates a perspective view of one potential embodiment of the locking hose clamp device of the present invention showing how the screw grooves catch on the insert component and lock the lock washer in place in accordance with the disclosed architecture;

FIG. 5 illustrates a perspective view of one potential embodiment of the locking hose clamp device of the present invention in accordance with the disclosed architecture; and

FIG. 6 illustrates a flowchart showing the method of locking hoses in place using one potential embodiment of the locking hose clamp device of the present invention to prevent leaks and spills in accordance with the disclosed architecture.

DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a locking hose clamp device that provides users with a small, easy to assemble and use locking hose clamp for everyday use. There is also a long-felt need in the art for a locking hose clamp device that is available in various sizes to accommodate different hoses and clamps for any job. Further, there is a long-felt need in the art for a locking hose clamp device that enables users to securely lock their hoses in place to prevent leaks and spills. Moreover, there is a long-felt need in the art for a device that features a poly/nylon insert which catches on screw grooves to prevent movement. Further, there is a long-felt need in the art for a locking hose clamp device that offers assurance to manufacturers that hoses and clamps will not loosen or give way. Finally, there is a long-felt need in the art for a locking hose clamp device that remains tight even when the apparatus upon which the device is secured or the device itself is subject to frequent shaking or vibration, or periodic impacts.

The present invention, in one exemplary embodiment, is a novel locking hose clamp device. The device is designed to function as a locking nut and remain tight. The device comprises a lock washer and an insert component. The device can be applied to a clamp and secured with a screw. The insert component is positioned around the screw, such that the screw is threaded into the insert component. The locking washer is secured around the screw, behind the head of the screw. When the user tightens the device, the screw threads catch onto corresponding threads within the insert component. The screw is threaded into the insert component and tightened down, such that the head of the screw contacts an edge of the insert component. The locking washer is then compressed which causes the screw to lock in place. The present invention also includes a novel method of locking hoses in place to prevent leaks and spills. The method includes the steps of providing a locking hose clamp device comprising a locking washer and an insert component applied to a clamp. The method also comprises positioning the locking washer on the screw behind the screw head. Further, the method comprises threading the screw into the insert component and tightening it down, such that the head of the screw contacts an edge of the insert component. Finally, compressing the locking washer which causes the screw to lock in place.

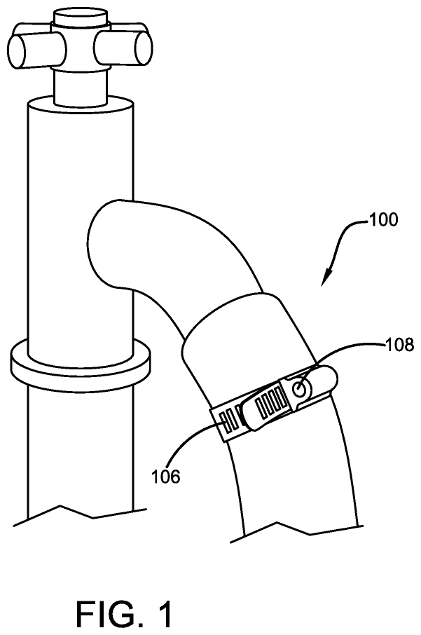

Referring initially to the drawings, FIG. 1 illustrates a perspective view of one embodiment of the locking hose clamp device 100 of the present invention in use. In the present embodiment, the locking hose clamp device 100 is an improved locking hose clamp device that locks hoses in place and prevents leaks and spills. The locking hose clamp device 100 further comprises a locking washer 102 and an insert component 104. The device 100 can be applied to a clamp 106 and secured with a screw 108. Specifically, the insert component 104 is positioned around the screw 108, such that the screw 108 is threaded into the insert component 104. The locking washer 102 is then secured around the screw 108, behind the head 200 of the screw 108. When the user tightens the device 100, the screw threads 202 catch onto corresponding threads 204 within the insert component 104. The screw 108 is threaded into the insert component 104 and tightened down, such that the head 200 of the screw 108 contacts an edge 206 of the insert component 104. The locking washer 102 is then compressed which causes the screw 108 to lock in place, securing the clamp 106.

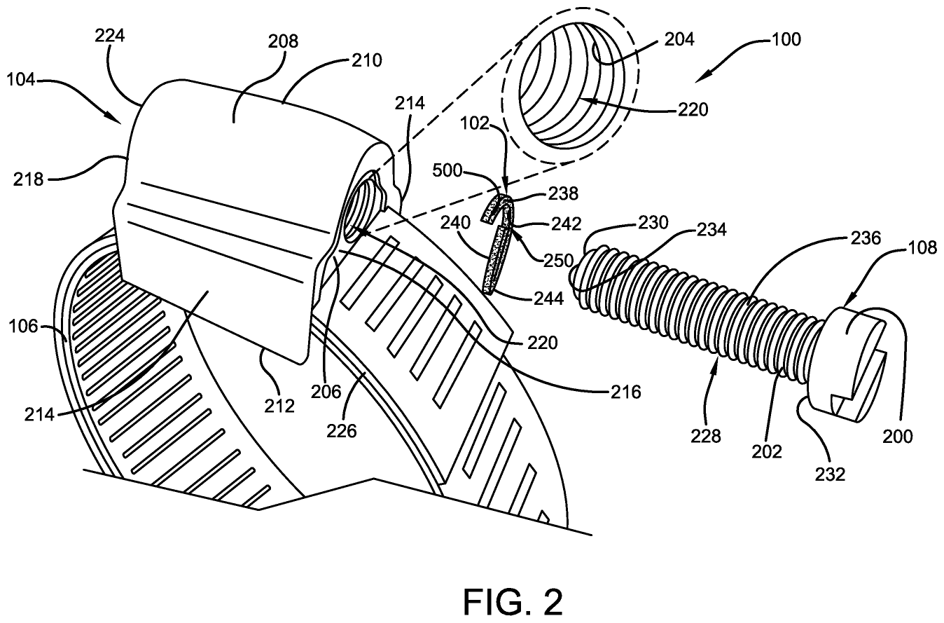

As shown in FIG. 2, the locking hose clamp device 100 comprises an insert component 104 and a locking washer 102 for securing a clamp 106 against leaks and spills. Specifically, the insert component 104 comprises a cylindrical housing 208 for accepting a screw 108 or other threaded securing means as is known in the art. The cylindrical housing 208 can be any suitable size and shape as is known in the art, as long as the housing 208 can retain a suitable screw 108. The cylindrical housing 208 comprises a top side 210, a bottom side 212, and a pair of opposing sides 214. Further, the cylindrical housing 208 comprises a front face 216, a rear face 218, and an interior cavity 220. The front face 216 further includes an opening 222 for accessing the interior cavity 220. The rear face 218 also includes an opening 224 for accessing the interior cavity 220. In one embodiment, the rear face 218 is closed and does not include an opening 224.

Furthermore, the interior cavity 220 comprises internal threads 204 which engage with the threads 202 of a screw 108 to secure the screw 108 within the interior cavity 220. Any suitable number of threads 204 can be utilized within the interior cavity 220 as is known in the art.

In one embodiment, the pair of opposing sides 214 of the cylindrical housing 208 secure around a suitable hose clamp 106. Any suitable clamp 106 can be utilized, as is known in the art. In one embodiment, the pair of opposing sides 214 can wrap all the way around the hose clamp 106 to secure it. In another embodiment, the pair of opposing sides 214 are secured only around the edges 226 of the hose clamp 108. Any suitable means for securing the pair of opposing sides 214 to the hose clamp 108 can be utilized as is known in the art.

Additionally, the screw 108 utilized with the device 100 is a typical screw as is known in the art, with a screw head 200, a cylindrical body 228 and a distal tip 230. More specifically, the cylindrical body 228 has a first end 232, a second end 234 and an exterior cylindrical surface portion 236. The cylindrical body 228 further comprises an exterior thread 202 disposed on and covering at least a portion of the exterior cylindrical surface portion 236 of the cylindrical body 228. Any suitable number of threads 202 can be utilized as is known in the art.

Further, the screw head 200 is positioned at the first end 232 and is configured to engage with a driver or other insertion tool to advance the screw 108. The screw 108 further includes a distal tip 230 positioned at the second end 234, opposite the head 200. The exterior thread 202 helically surrounds the cylindrical body 228 and engages with the internal threads 204 of the insert component 104. The cylindrical body 228, the head 200, and the tip 230 are preferably formed as a single integral component, unit, or device.

Additionally, in one embodiment, the locking washer 102 utilized with the device 100 is an essentially annular body having a first face 238, a second face 240, an inner edge 242 and an outer edge 244. The locking washer 102 further includes first 246 and second ends 248, respectively, and a central opening 250, forming a split helical locking washer 102. The locking washer 102 can be manufactured in different sizes, to be used with threaded fasteners of a wide variety of diameters. Thus, the diameter of the central opening 250, the width of the locking washer 102 between the inner edge 242 and outer edge 244, and the thickness of the locking washer 102 between the first face 238 and the second face 240 all can be varied as necessary for the specific application and use to which the locking washer 102 will be placed.

Generally, the locking washer 102 can be made of a wide variety of materials, commonly metal such as various steels, brass, etc., or even polymers, such as nylon, polycarbonate, etc. Further, platings and/or coatings can also be applied to the locking washer 102 as well. In one embodiment, the locking washer 102 is comprised of suitable dimensions and formed from a single piece of high carbon spring steel, hot rolled, or cold drawn, with an opening 250 punched therethrough for the reception of a screw 108 or other securing means as is known in the art. Specifically, the locking washer 102 is made from a single piece folded upon itself creating an upper end (first end 246) and a lower end (second end 248), wherein the ends 246, 248 are spaced apart in a resting position.

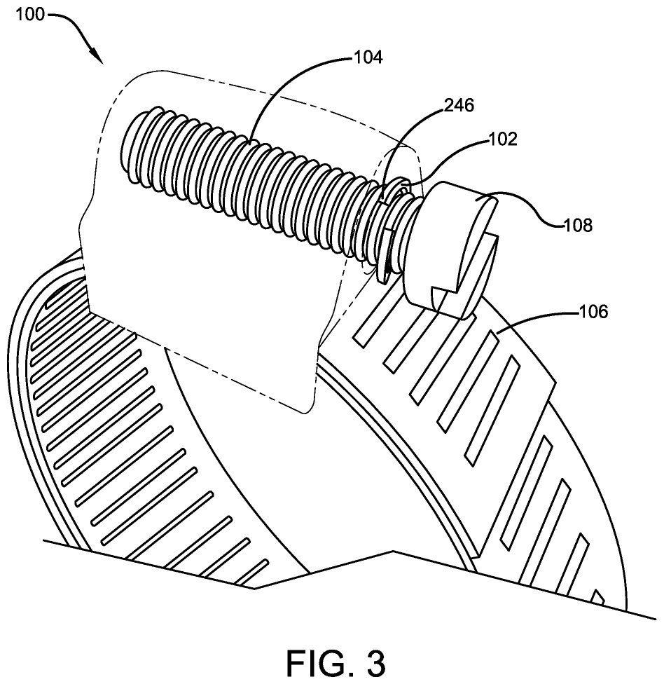

As shown in FIG. 3, in a resting position, the ends 246, 248 of the locking washer 102 do not touch and rest slightly adjacent each other. However, once the screw 108 is threaded into the insert component 104 and tightened down, the head 200 of the screw 108 contacts an edge 206 of the insert component 104, compressing the locking washer 102 such that its ends 246, 248 now abut and contact each other without overlapping.

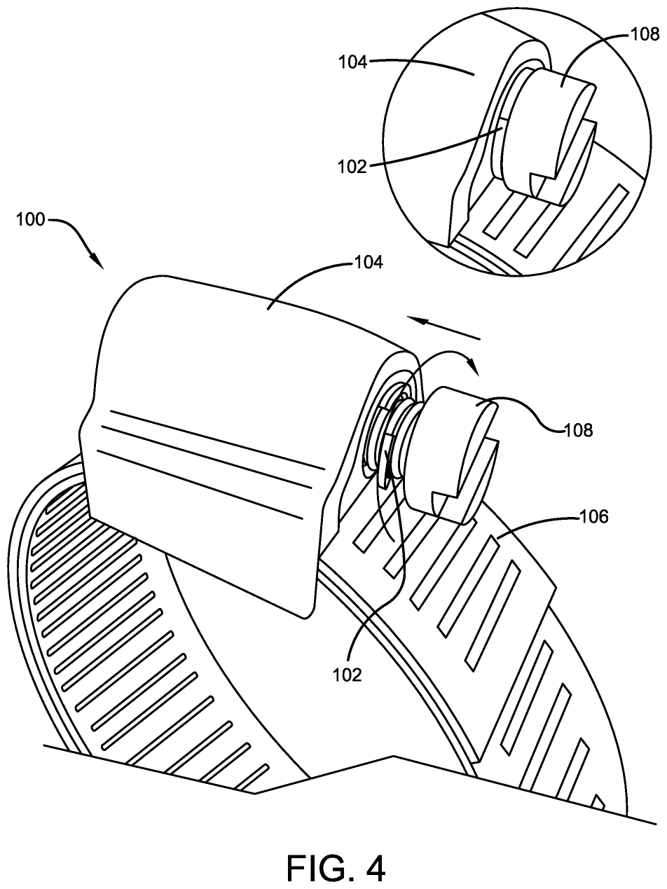

Specifically, as shown in FIG. 4, when the screw 108 is screwed tightly against the locking washer 102 under sufficient pressure, it will cause the locking washer 102 to flatten out, hence its high spring resistance will be exerted to maintain the screw 108 in tight contact with the threads 204 of the insert component 104, and when the screw 108 is loosened, the locking washer 102 will spring back into resting position.

Additionally, when the screw 108 is tightly adjusted in its locked position in contact with the locking washer 102, the screw 108 will rest upon the first face 238 of the locking washer 102, which formation securely prevents the screw 108 from turning in either direction, thereby preventing the screw 108 from loosening, while the spring resistance of the locking washer 102 and its compression by the screw 108 exerts sufficient pressure to maintain the screw 108 in a locked position in contact with the threads 204 of the insert component 104 under any and all conditions of service.

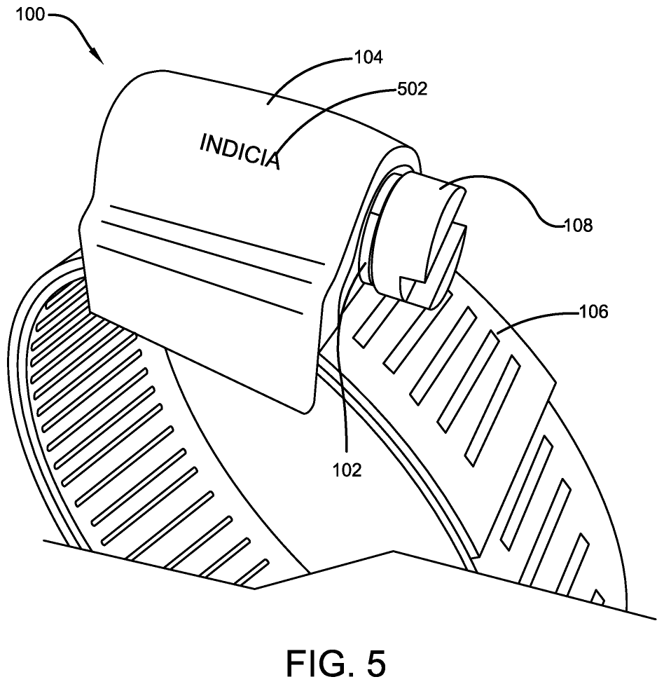

As shown in FIG. 5, in one embodiment, the locking washer 102 includes texturing 500 provided on at least one of the first face 238 and/or the second face 240. Preferably, texturing 500 is present on both the first face 238 and the second face 240. Texturing 500 comprises a plurality of individual dimples, or other depressions in the first face 238 and the second face 240. For example, texturing 500 can comprise randomly positioned dimples or geometrically ordered depressions, such as inverted pyramids pressed into each face 238, 240. Texturing 500 provides frictional resistance between the surface of the locking washer 102 and the material against which the locking washer 102 rests, to resist vibration or other movement. The textured surface 500 reduces the surface area which comes into contact with the meeting material, thereby creating greater surface friction as compared to a standard, smooth, non-textured helical washer 102. The textured surface 500 is configured in such a way as to not adversely mar or otherwise effect the mating material surface.

In yet another embodiment, the locking hose clamp device 100 comprises a plurality of indicia 502. The insert component 104 may include advertising, a trademark, or other letters, designs, or characters, printed, painted, stamped, or integrated into the clamp 106, or any other indicia 502 as is known in the art. Specifically, any suitable indicia 502 as is known in the art can be included, such as, but not limited to, patterns, logos, emblems, images, symbols, designs, letters, words, characters, animals, advertisements, brands, etc., that may or may not be hose clamp or brand related.

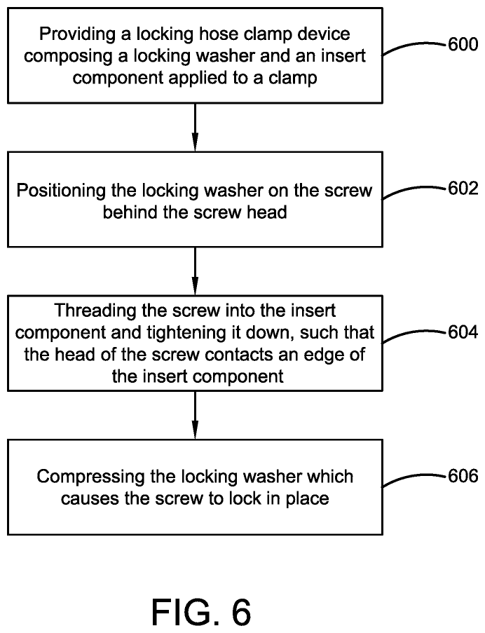

FIG. 6 illustrates a flowchart of the method of locking hoses in place to prevent leaks and spills. The method includes the steps of at 600, providing a locking hose clamp device comprising a locking washer and an insert component applied to a clamp. The method also comprises at 602, positioning the locking washer on the screw behind the screw head. Further, the method comprises at 604, threading the screw into the insert component and tightening it down, such that the head of the screw contacts an edge of the insert component. Finally, at 606, compressing the locking washer which causes the screw to lock in place.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “locking hose clamp device” and “device” are interchangeable and refer to the locking hose clamp device 100 of the present invention.

Notwithstanding the foregoing, the locking hose clamp device 100 of the present invention can be of any suitable size and configuration as is known in the art without affecting the overall concept of the invention, provided that it accomplishes the above-stated objectives. One of ordinary skill in the art will appreciate that the locking hose clamp device 100 as shown in FIGS. 1-6 are for illustrative purposes only, and that many other sizes and shapes of the locking hose clamp device 100 are well within the scope of the present disclosure. Although the dimensions of the locking hose clamp device 100 are important design parameters for user convenience, the locking hose clamp device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A locking hose clamp device for preventing leaks and spills, the locking hose clamp device comprising:
a locking washer; and
an insert component;
wherein the insert component is applied to a hose clamp and secured with a screw;
wherein the screw is threaded into the insert component and tightened down; and
further wherein the locking washer is secured around the screw to lock the screw in place on the hose clamp.

2. The locking hose clamp device of claim 1, wherein the locking washer is secured around the screw, behind a head of the screw.

3. The locking hose clamp device of claim 2, wherein the head of the screw contacts an edge of the insert component when tightened down.

4. The locking hose clamp device of claim 3, wherein the locking washer is compressed when the screw is tightened down, locking the screw in place.

5. The locking hose clamp device of claim 1, wherein the insert component comprises a cylindrical housing for accepting the screw.

6. The locking hose clamp device of claim 5, wherein the cylindrical housing comprises a top side, a bottom side, and a pair of opposing sides.

7. The locking hose clamp device of claim 6, wherein the cylindrical housing comprises a front face, a rear face, and an interior cavity.

8. The locking hose clamp device of claim 7, wherein each of the front face and the rear face comprises an opening for accessing the interior cavity.

9. The locking hose clamp device of claim 8, wherein the interior cavity comprises a plurality of internal threads which engage with a plurality of threads on the screw.

10. The locking hose clamp device of claim 9, wherein the pair of opposing sides of the cylindrical housing secure around the hose clamp.

11. The locking hose clamp device of claim 1, wherein the screw comprises a screw head, a cylindrical body with a cylindrical surface portion comprising an exterior thread, and a distal tip.

12. The locking hose clamp device of claim 1, wherein the locking washer comprises a first face, a second face, an inner edge, and an outer edge.

13. The locking hose clamp device of claim 12, wherein the locking washer comprises a first end, a second end, and a central opening forming a split helical locking washer.

14. The locking hose clamp device of claim 13, wherein in a resting position, the first and second ends do not touch and rest slightly adjacent to each other.

15. The locking hose clamp device of claim 14, wherein in a compressed position, the first and second ends abut and contact each other without overlapping.

16. A locking hose clamp device for preventing leaks and spills, the locking hose clamp device comprising:
a locking washer secured around a screw, behind a head of the screw; and
an insert component applied to a hose clamp;
wherein the screw is threaded into the insert component and tightened down, thereby compressing the locking washer; and
wherein in a resting position, a first end and a second end of the locking washer do not touch and rest slightly adjacent to each other; and
further wherein in a compressed position, the locking washer flattens out due to pressure from the screw tightening down, causing the first and second ends to abut and contact each other without overlapping, thereby securing the screw in position.

17. The locking hose clamp device of claim 16, wherein when the screw is loosened, the locking washer springs back to the resting position.

18. The locking hose clamp device of claim 17, wherein the locking washer comprises a texturing on each of a first face and a second face of the locking washer.

19. The locking hose clamp device of claim 16 further comprising a plurality of indicia.

20. A method of locking a hose in place to prevent leakage and spills, the method comprising the steps of:
providing a locking hose clamp device comprising a locking washer, a screw and an insert component applied to a clamp;
positioning the locking washer on the screw behind the screw head;
threading the screw into the insert component and tightening it down, such that the head of the screw contacts an edge of the insert component; and
compressing the locking washer, which causes the screw to lock in place.
